(19) United States
(12) Patent Application Publication
(10) Pub. No.: US 2026/0227673 A1
(43) Pub. Date: Aug. 6, 2026

(54) VACUUM SQUEEZED LIGHT PRODUCING DEVICE AND VACUUM SQUEEZED LIGHT PRODUCING METHOD

(71) Applicant: TOHOKU UNIVERSITY, Sendai-shi, Miyagi (JP)

(72) Inventors: Nobuyuki MATSUDA, Sendai-shi (JP); Shogo KIMURA, Sendai-shi (JP)

(21) Appl. No.: 19/158,312

(22) PCT Filed: Jul. 3, 2023
(86) PCT No.: PCT/JP2023/024633

§ 371 Date: Oct. 14, 2025

Related U.S. Application Data
(60) Provisional application No. 63/447,894, filed on Feb. 24, 2023.

(51) Int. Cl. G02F 1/35

(52) U.S. Cl. CPC G02F 1/3503; G02F 1/3536

(57) ABSTRACT

A squeezed vacuum producing device includes a two-wavelength optical pulse light source with a coaxial path which synchronizes two optical pulses configured with a first optical pulse having an optical frequency f1 and a second optical pulse having an optical frequency f2 (f1≠f2). The squeezed vacuum producing device outputs a two-wavelength optical pulse in a state where a relative phase between the first optical pulse and the second optical pulse does not fluctuate Furthermore, a squeezed vacuum producing unit that includes a nonlinear optical medium, inputs the two-wavelength optical pulse output by the two-wavelength optical pulse light source to the nonlinear optical medium, generates squeezed vacuum having an optical frequency fo (fo≠f1 and fo≠f2) by a nonlinear optical effect, and outputs the squeezed vacuum.

### CROSS-REFERENCE TO RELATED APPLICATIONS

This application is the U.S. National Stage entry of International Application No. PCT/JP2023/024633, filed on Jul. 3, 2023, which, in turn, claims priority to U.S. Provisional Patent Application No. 63/447,894, filed on Feb. 24, 2023, both of which are hereby incorporated herein by reference in their entireties for all purposes.

### TECHNICAL FIELD

The present invention relates to a squeezed vacuum producing device and a squeezed vacuum producing method.

### BACKGROUND ART

As one of methods for implementing large-scale quantum information processing, quantum information processing using squeezed vacuum has been attracting attention. When squeezed vacuum is expanded in the basis of the number of photons, the squeezed vacuum is expressed as a quantum mechanical superposition state of eigenstates (even-number states) in which the number of photons is an even number. It is known that squeezed vacuum has different quantum characteristics compared to normal laser light.

Squeezed vacuum can be produced using, for example, an optical medium having a nonlinear optical characteristic (nonlinear optical medium). As an example of a specific method for producing squeezed vacuum, a method is known in which spontaneous four-wave mixing (SFWM) is caused in a nonlinear optical medium having third order nonlinearity to produce single-mode squeezed vacuum (SMSV) light.

FIG. 1 is a schematic diagram showing a process of producing single-mode squeezed vacuum light using spontaneous four-wave mixing. In this process, a two-wavelength optical pulse is input into a nonlinear optical medium having third order nonlinearity. The two-wavelength optical pulse is configured with a first optical pulse having an optical frequency f1 (optical angle frequency ω1) and a second optical pulse having an optical frequency f2 (optical angle frequency ω2) (f1≠f2, ω1≠ω2). The first optical pulse and the second optical pulse are temporally synchronized.

When such a two-wavelength optical pulse is input to a third order nonlinear optical medium, a photon pair configured with two photons is generated in the medium. The photons have the same optical frequency fo (optical angular frequency ωo). According to the energy conservation law, the optical frequency fo (optical angle frequency ωo) satisfies 2fo=f1+f2 (2ωo=ω1+ω2). In this manner, photons are generated in pairs in the nonlinear optical medium, and thus the number of photons generated in the medium is always an even number. The number of photon pairs (the number of pairs) generated in the nonlinear optical medium depends on a quantum probability. Thus, light produced in the above process is squeezed vacuum represented as a quantum mechanical superposition state of an even-number state. More specifically, since the photons have the same optical frequency fo, single-mode vacuum-squeezed light is produced.

Non-Patent Document 1 discloses an example of a device (squeezed vacuum producing device) that generates single-mode squeezed vacuum light using the above process. FIG. 2 is a schematic view showing the squeezed vacuum producing device disclosed in Non-Patent Document 1. As shown in FIG. 2, a squeezed vacuum producing device 101 includes a light source 111, two wavelength division multiplexing filters (WDM filters) 112 including a first wavelength division filter 112A and a second wavelength division filter 112B, and a nonlinear optical medium 122. The nonlinear optical medium 122 has third order nonlinearity.

In a two-wavelength optical pulse light source 10, the light source 111 and the pair of wavelength division filters 112 function as the two-wavelength optical pulse light source 110 that generates the two-wavelength optical pulse described above. A specific description will be given below.

The light source 111 inputs an optical pulse to the first wavelength division filter 112A. The optical pulse input to the first wavelength division filter 112A has a broadband frequency spectrum including at least the optical frequencies f1 and f2.

The first wavelength division filter 112A decomposes the input optical pulse into each frequency. The first wavelength division filter 112A outputs the decomposed optical pulse to a path different for each frequency. The first wavelength division filter 112A in the illustrated example outputs a pulse (first optical pulse) having the optical frequency f1 to a first path P1, outputs a pulse (second optical pulse) having the optical frequency f2 to a second path P2, and outputs the other optical frequencies to the other paths (not shown). The first optical pulse output to the first path P1 and the second optical pulse output to the second path P2 are input to the second wavelength division filter 112B. The pulses output to the other paths are not input to the second wavelength division filter 112B.

The second wavelength division filter 112B multiplexes the first optical pulse having the optical frequency f1 and the second optical pulse having the optical frequency f2 to generate a two-wavelength optical pulse. The second wavelength division filter 112B outputs the generated two-wavelength optical pulse to the nonlinear optical medium 122. In this manner, in the squeezed vacuum producing device 101 in Non-Patent Document 1, a two-wavelength pulse is output through the process in which the first optical pulse and the second optical pulse are spatially separated and synthesized by the two wavelength division filters 112.

When the two-wavelength optical pulse is input to the nonlinear optical medium 122, the above-mentioned spontaneous four-wave mixing occurs. Thereby, single-mode squeezed vacuum light having an optical frequency fo is generated.

### CITATION LIST

### Non-Patent Document

Non-Patent Document 1: Paesani, S., Ding, Y., Santagati, R. et al. Generation and sampling of quantum states of light in a silicon chip. Nat. Phys. 15, 925-929 (2019). https://doi.org/10.1038/s41567-019-0567-8

### SUMMARY OF INVENTION

### Technical Problem

Incidentally, in the squeezed vacuum producing device 101 of Non-Patent Document 1, the optical path length of the first path P1 and the optical path length of the second path P2 may independently change over time (may fluctuate over time). For example, when the paths P1 and P2 are configured with optical fibers, the lengths of the optical fibers change depending on changes in the temperature of the optical fibers. Due to the optical path length of the first path P1 and the optical path length of the second path P2 changing independently, a difference in phase (relative phase) between the first optical pulse and the second optical pulse changes over time (fluctuates over time) in the second wavelength division filter 112B.

Further, in the process of generating squeezed vacuum using spontaneous four-wave mixing, it is known that not only SMSV light generated from two-wavelength optical pulses but also other photons (noise photons) are generated. The noise photons are independently generated from each of the first optical pulse having the optical frequency f1 and the second optical pulse having the optical frequency f2. Examples of the noise photon include Raman scattered light, leakage light, and two-mode squeezed vacuum (TMSV) light. It is known that it is difficult to completely eliminate such noise photons.

In the squeezed vacuum producing device 101 described in Non-Patent Document 1, noise photons generated from the first optical pulse and noise photons generated from the second optical pulse interfere with each other. Here, as described above, when a relative phase between the first optical pulse and the second optical pulse fluctuates over time, the intensity of interference between noise photons also fluctuates over time. When an interference intensity fluctuates over time, it is difficult to accurately measure and evaluate SMSV light.

The present invention has been made in view of such circumstances, and an object thereof is to provide a squeezed vacuum producing device and a squeezed vacuum producing method which are capable of curbing fluctuations over time in the interference intensity of noise photons.

### Solution to Problem

In order to solve the above problem, a squeezed vacuum producing device according to a first aspect of the present invention includes a two-wavelength optical pulse light source with a coaxial path which synchronizes two optical pulses configured with a first optical pulse having an optical frequency f1 and a second optical pulse having an optical frequency f2 (f1≠f2) and outputs a two-wavelength optical pulse in a state where a relative phase between the first optical pulse and the second optical pulse does not fluctuate, and a squeezed vacuum producing means that includes a nonlinear optical medium, inputs the two-wavelength optical pulse output by the two-wavelength optical pulse light source to the nonlinear optical medium, generates squeezed vacuum having an optical frequency fo (fo≠f1 and fo≠f2) by a nonlinear optical effect, and outputs the squeezed vacuum.

In a second aspect of the present invention according to the squeezed vacuum producing device of the first aspect, the squeezed vacuum producing device further includes an optical pulse attenuation means for selectively attenuating the two-wavelength optical pulse from the light output by the squeezed vacuum producing means.

In a third aspect of the present invention according to the squeezed vacuum producing device of the first or second aspect, the two-wavelength optical pulse light source includes a single optical pulse light source having a frequency spectral width including at least the optical frequencies f1 and f2 or a spectral shape including the optical frequencies f1 and f2, and an optical wavelength filter for inputting the single optical pulse light source and outputting a two-wavelength optical pulse of the optical frequencies f1 and f2.

In a fourth aspect of the present invention according to the squeezed vacuum producing device of the third aspect, the optical wavelength filter is a programmable optical filter, a wavelength selective filter, or a plurality of notch filters connected in cascade.

In a fifth aspect of the present invention according to the squeezed vacuum producing device of any one of the first to fourth aspects, the squeezed vacuum producing means includes an attenuation means for attenuating an intensity of optical noise at the optical frequency fo in the two-wavelength optical pulse light source to an intensity ratio of 0.01 or less of a light intensity of the squeezed vacuum.

In order to solve the above problem, a squeezed vacuum producing method according to a sixth aspect of the present invention includes causing a two-wavelength optical pulse light source to synchronize two optical pulses configured with a first optical pulse having an optical frequency f1 and a second optical pulse having an optical frequency f2 (f1≠f2) in a state where a relative phase between the first optical pulse and the second optical pulse does not fluctuate, and to output a two-wavelength optical pulse, and inputting the synchronized and output two-wavelength optical pulse to a nonlinear optical medium to generate squeezed vacuum having an optical frequency fo (fo≠f1 and fo≠f2) by a nonlinear optical effect and outputting the squeezed vacuum.

### Advantageous Effects of Invention

According to the above aspects of the present invention, it is possible to provide a squeezed vacuum producing device and a squeezed vacuum producing method which are capable of curbing fluctuations over time in the interference intensity of noise photons.

### BRIEF DESCRIPTION OF DRAWINGS

FIG. 1 is a schematic diagram showing a process of producing single-mode squeezed vacuum light using spontaneous four-wave mixing.

FIG. 2 is a schematic view showing a squeezed vacuum producing device of the related art.

FIG. 3 is a schematic view showing a squeezed vacuum producing device according to an embodiment of the present invention.

FIG. 4A is a diagram showing an example of an optical wavelength filter according to an embodiment of the present invention.

FIG. 4B is a diagram showing another example of an optical wavelength filter according to an embodiment of the present invention.

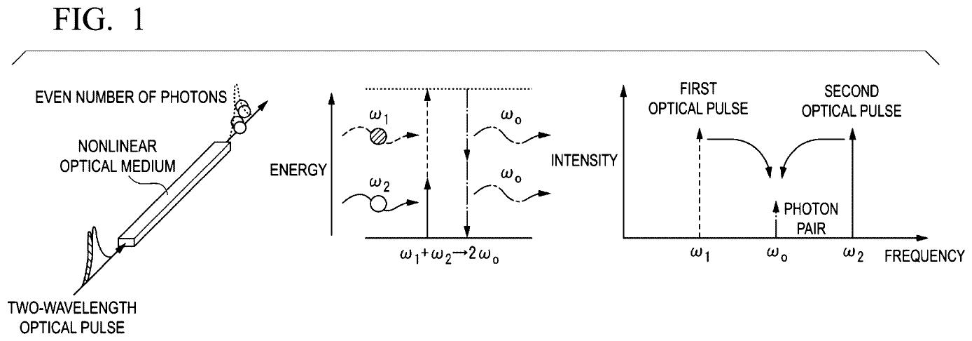

### DESCRIPTION OF EMBODIMENTS

Hereinafter, a squeezed vacuum producing device according to an embodiment of the present invention will be described with reference to the drawings.

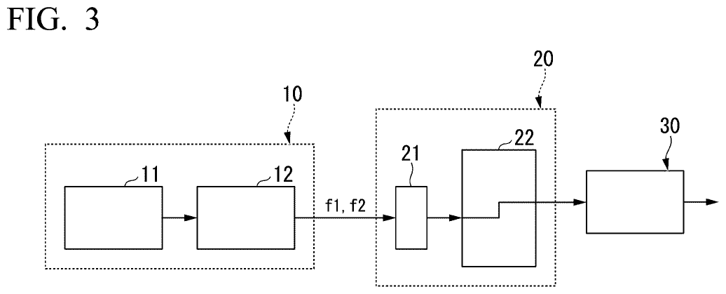

As shown in FIG. 3, a squeezed vacuum producing device 1 according to the present embodiment includes a two-wavelength optical pulse light source 10, a squeezed vacuum producing means (squeezed vacuum producing unit) 20, and an optical pulse attenuation means 30 (optical pulse attenuation unit). The two-wavelength optical pulse light source 10 outputs two-wavelength optical pulses toward the squeezed vacuum producing means 20. The squeezed vacuum producing means 20 generates and outputs squeezed vacuum by a nonlinear optical effect (for example, spontaneous four-wave mixing). The light output from the squeezed vacuum producing means 20 is output to the outside of the squeezed vacuum producing device 1 via the optical pulse attenuation means 30.

The two-wavelength optical pulse light source 10 generates a two-wavelength optical pulse by synchronizing two pulses including a first optical pulse having an optical frequency f1 and a second optical pulse having an optical frequency f2 (f1≠f2). The two-wavelength optical pulse light source 10 outputs the generated two-wavelength optical pulse to a coaxial path in a state where a relative phase between the first optical pulse and the second optical pulse does not fluctuate. Specifically, the two-wavelength optical pulse light source 10 according to the present embodiment includes a single optical pulse light source 11 and an optical wavelength filter 12. The two-wavelength optical pulse light source 10 may include an optical amplifier (not shown) that amplifies the intensity of an optical pulse.

The optical pulse light source 11 outputs an optical pulse to the optical wavelength filter 12. The optical pulse light source 11 has a frequency spectral width including at least the optical frequencies f1 and f2. Alternatively, the optical pulse light source 11 may have a spectral shape including the optical frequencies f1 and f2.

Although not shown in the drawing in detail, the optical pulse light source 11 may include a mode synchronous laser and a pulse compressor. The mode synchronous laser outputs an optical pulse to the pulse compressor. The pulse compressor expands the spectrum of the optical pulse output from the mode synchronous laser. Specifically, the pulse compressor expands the spectrum of the optical pulse output from the mode synchronous laser so as to include the optical frequencies f1 and f2. The pulse compressor may have nonlinearity.

The optical wavelength filter 12 receives the optical pulse output from the optical pulse light source 11 as an input and outputs the two-wavelength optical pulse having the optical frequencies f1 and f2. More specifically, the optical wavelength filter 12 cuts out (transmits) the first optical pulse having the optical frequency f1 and the second optical pulse having the optical frequency f2 (f1≠f2) from the optical pulse output from the optical pulse light source 11. Then, the optical wavelength filter 12 multiplexes the first optical pulse and the second optical pulse that have been cut out, and outputs the multiplexed optical pulse to a coaxial path. Both the first optical pulse and the second optical pulse are derived from the same optical pulse output from the optical pulse light source 11. For this reason, the optical wavelength filter 12 outputs the two-wavelength optical pulse in a state where the first optical pulse and the second optical pulse are temporally synchronized.

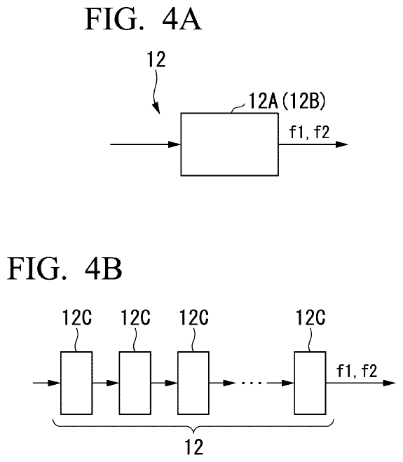

As shown in FIG. 4A, as the optical wavelength filter 12, for example, a programmable optical filter 12A or a wavelength selective filter (WSS; wavelength selective switch) 12B can be adopted. The programmable optical filter 12A or the wavelength selective filter 12B is set to transmit the optical frequencies f1 and f2.

Alternatively, as shown in FIG. 4B, a plurality of notch filters 12C connected in cascade may be adopted as the optical wavelength filter 12. Each of the notch filters 12C attenuates light having a specific optical frequency (hereinafter referred to as “attenuation frequency”) among light beams that are input to the notch filter 12C. The attenuation frequency of each notch filter 12C is set to an optical frequency other than f1 and f2. In addition, the attenuation frequencies are different from each other among the plurality of notch filters 12C. By connecting such a plurality of notch filters 12C in cascade, the optical wavelength filter 12 as a whole can attenuate light having frequencies other than the optical frequencies f1 and f2. That is, only the optical frequency f1 and f2 components are extracted from the optical pulse input to the optical wavelength filter 12, and a two-wavelength optical pulse can be generated.

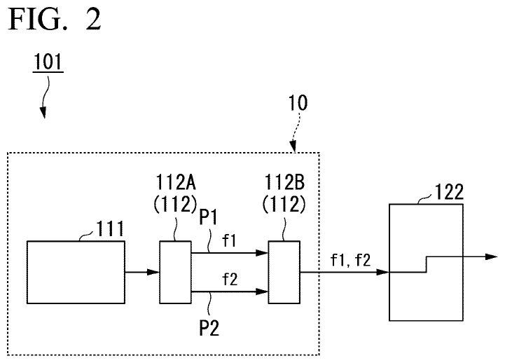

Also when any of the programmable optical filter 12A, the wavelength selective filter 12B, and the plurality of notch filters 12C connected in cascade is adopted as the optical wavelength filter 12, the first optical pulse having the optical frequency f1 and the second optical pulse having the optical frequency f2 do not branch off to different paths. In other words, the first optical pulse and the second optical pulse travel on a coaxial path. This is different from a squeezed vacuum producing device 101 of the related art (a pair of wavelength division filters 112A and 112B) shown in FIG. 2 in which the first optical pulse and the second optical pulse travel through different paths P1 and P2.

By adopting the optical wavelength filter 12 having such a coaxial path, the optical path length of the path through which the first optical pulse travels and the optical path length of the path through which the second optical pulse travels become equal to each other. More specifically, since the two optical pulses travel through a common path, even when the optical path length of the common path changes, a difference in optical path length does not occur between the path through which the first optical pulse travels and the path through which the second optical pulse travels. Thus, the optical wavelength filter 12 (two-wavelength optical pulse light source 10) according to the present embodiment can output a two-wavelength optical pulse in a state where a relative phase between the first optical pulse and the second optical pulse does not fluctuate.

Note that the configuration of the two-wavelength optical pulse light source 10 (the optical pulse light source 11 and the optical wavelength filter 12) is not particularly limited and can be changed as appropriate as long as the first optical pulse and the second optical pulse can be synchronized and the two-wavelength optical pulse can be output in a state where a relative phase between the first optical pulse and the second optical pulse does not fluctuate.

As shown in FIG. 3, the squeezed vacuum producing means 20 includes a nonlinear optical medium 22. The squeezed vacuum producing means 20 inputs the two-wavelength optical pulse output by the two-wavelength optical pulse light source 10 to the nonlinear optical medium 22, and generates and outputs squeezed vacuum having an optical frequency fo (fo≠f1 and fo≠f2) by a nonlinear optical effect.

The nonlinear optical medium 22 has, for example, a third order nonlinear optical characteristic. The nonlinear optical effect generated in the nonlinear optical medium 22 for producing squeezed vacuum is spontaneous four-wave mixing, and 2fo=f1+f2 is established.

The nonlinear optical medium 22 is configured with, for example, an optical waveguide. The optical waveguide includes a core and a cladding. The refractive index of the core is higher than the refractive index of the cladding. Thereby, the optical waveguide can confine light in the core.

The cladding of the optical waveguide may be formed of, for example, a glass material. The core may be formed of, for example, at least one of a semiconductor material, a compound semiconductor material, and a dielectric material. More specifically, the core may be formed of at least one of Si, GaAs, AlGaAs, GaN, InP, LiNbO3, PPLN, PPKTP, Si3N4, and SiC. In particular, a configuration in which the core is formed of Si has the following three advantages. A first advantage is that a difference in refractive index between the core and the cladding is easily increased. By increasing the difference in refractive index, the light intensity in the core can be locally increased, and the occurrence of a nonlinear optical effect can be promoted. A second advantage is that Si has high third order nonlinear characteristics. A third advantage is that integration is easy.

Note that the type of nonlinear optical medium 22 is not limited and can be changed as appropriate as long as the squeezed vacuum can be produced and output by a nonlinear optical effect. For example, the nonlinear optical medium 22 may be an optical resonator having the above-mentioned optical waveguide. Alternatively, the nonlinear optical medium 22 may be an optical fiber having a core and a cladding.

The squeezed vacuum producing means 20 may further include an attenuation means (attenuation unit) 21 in addition to the nonlinear optical medium 22 (see FIG. 3). The attenuation means 21 is also referred to as a first attenuation means (first attenuation unit).

The attenuation means (first attenuation means) 21 attenuates optical noise at the optical frequency fo included in the two-wavelength optical pulse output by the two-wavelength optical pulse light source 10. For example, the attenuation means 21 may attenuate the intensity of the optical noise at the optical frequency fo to an intensity ratio of 0.01 or less of the light intensity of the squeezed vacuum output by the nonlinear optical medium 22. As the attenuation means 21, for example, a notch filter that attenuates light having an optical frequency fo can be adopted.

By providing the attenuation means 21, it is possible to reduce a noise component (light other than the squeezed vacuum) having an optical frequency fo in light output by the nonlinear optical medium 22. Thereby, it becomes easy to extract the squeezed vacuum having the optical frequency fo from the light output by the nonlinear optical medium 22.

Although not shown in the drawing in detail, the squeezed vacuum producing means 20 may include another attenuation means instead of (or in addition to) the attenuation means (first attenuation means) 21. The attenuation means is also referred to as a second attenuation means (second attenuation unit).

The second attenuation means attenuates optical noise at optical frequencies other than the optical frequency f1 and the optical frequency f2, which are included in the two-wavelength optical pulse output by the two-wavelength optical pulse light source 10. For example, the second attenuation means may attenuate the sum of the intensities of the optical noise at the optical frequencies other than the optical frequency f1 and the optical frequency f2 to an intensity ratio of 0.01 or less of the light intensity of the squeezed vacuum output by the nonlinear optical medium 22. As the second attenuation means, for example, at least one of a programmable optical filter, a wavelength selective filter (wavelength selective switch), and a notch filter can be adopted.

By providing the second attenuation means, it is possible to reduce a residual component of light output by the two-wavelength optical pulse light source 10 in light output by the nonlinear optical medium 22. Note that the “residual component” means, for example, a component that cannot be completely removed by the optical wavelength filter 12 in light output by the optical pulse light source 11. The “residual component” may have, for example, a component of the optical frequency fo. The “residual component” may also have components of optical frequencies other than the optical frequencies fo, f1, and f2. By reducing such a residual component, it becomes easier to extract squeezed vacuum from light output by the nonlinear optical medium 22.

The optical pulse attenuation means 30 is also referred to as a third attenuation means (third attenuation unit). Light output by the squeezed vacuum producing means 20 is input to the optical pulse attenuation means 30.

The optical pulse attenuation means 30 selectively attenuates the two-wavelength optical pulse from the light output by the squeezed vacuum producing means 20. As the optical pulse attenuation means 30, for example, a band-pass filter can be adopted.

A part of the two-wavelength optical pulse input to the nonlinear optical medium 22 may pass through the nonlinear optical medium 22 as it is without being converted into squeezed vacuum. That is, the light output by the nonlinear optical medium 22 may include a two-wavelength optical pulse. By providing the above-mentioned optical pulse attenuation means 30, the two-wavelength optical pulse passing through the nonlinear optical medium 22 can be attenuated in the light output by the nonlinear optical medium 22. Thereby, it becomes easier to extract the squeezed vacuum from the light output by the nonlinear optical medium 22.

Note that, in the squeezed vacuum producing device 1 described above, the frequency spectrum of first pulse light, the frequency spectrum of second pulse light, the frequency spectrum of squeezed vacuum, refractive index dispersion characteristics of the nonlinear optical medium 22, and the length (optical path length) of the nonlinear optical medium 22 may be designed such that the joint spectrum of squeezed vacuum to be generated becomes a single mode. Such a design may be performed on the basis of, for example, Japanese Patent Application Laid-Open No. 2013-15656.

Next, a squeezed vacuum producing method using the squeezed vacuum producing device 1 configured as described above will be described.

First, a two-wavelength optical pulse output step is performed. In the two-wavelength optical pulse output step, the two-wavelength optical pulse light source 10 having a coaxial path synchronizes two optical pulses configured with a first optical pulse having an optical frequency f1 and a second optical pulse having an optical frequency f2 (f1≠f2), and outputs the two-wavelength optical pulse. At this time, the two-wavelength optical pulse light source 10 synchronizes the two optical pulses in a state where a relative phase between the first optical pulse and the second optical pulse does not fluctuate, and outputs the two-wavelength optical pulse.

Next, a squeezed vacuum output step is performed. In the squeezed vacuum output step, the two-wavelength optical pulse synchronously output in the two-wavelength optical pulse output step is input to the nonlinear optical medium 22. Thereby, squeezed vacuum having an optical frequency fo (fo≠f1 and fo≠f2) is generated by a nonlinear optical effect and output.

Finally, an optical pulse attenuation step is performed. In the optical pulse attenuation step, the two-wavelength optical pulse is selectively attenuated from the light output in the squeezed vacuum output step, for example, by using the optical pulse attenuation means 30.

As described above, the squeezed vacuum producing device 1 according to the present embodiment includes the two-wavelength optical pulse light source 10 with a coaxial path which synchronizes two optical pulses configured with a first optical pulse having an optical frequency f1 and a second optical pulse having an optical frequency f2 (f1≠f2) and outputs the two-wavelength optical pulse in a state where a relative phase between the first optical pulse and the second optical pulse does not fluctuate, and the squeezed vacuum producing means 20 that includes the nonlinear optical medium 22, inputs the two-wavelength optical pulse output by the two-wavelength optical pulse light source 10 to the nonlinear optical medium 22, generates squeezed vacuum having an optical frequency fo (fo≠f1 and fo≠f2) by a nonlinear optical effect, and outputs the squeezed vacuum. Further, in the squeezed vacuum producing method according to the present embodiment, the two-wavelength optical pulse light source 10 having a coaxial path synchronizes two optical pulses configured with a first optical pulse having an optical frequency f1 and a second optical pulse having an optical frequency f2 (f1≠f2) in a state where a relative phase between the first optical pulse and the second optical pulse does not fluctuate, outputs a two-wavelength optical pulse, and inputs the synchronized and output two-wavelength optical pulse to the nonlinear optical medium 22 to generate squeezed vacuum having an optical frequency fo (fo≠f1 and fo≠f2) by a nonlinear optical effect and output the squeezed vacuum.

According to this configuration, it is possible to generate squeezed vacuum in a state where a relative phase between the first optical pulse and the second optical pulse does not fluctuate. Thereby, it is possible to reduce the intensity of interference between noise photons caused by noise photons generated from the first optical pulse and noise photons generated from the second optical pulse. By reducing the intensity of interference between noise photons, an effect of facilitating accurate measurement and evaluation of squeezed vacuum is also obtained. In addition, the squeezed vacuum producing device 1 and the squeezed vacuum producing method according to the present embodiment in which the intensity of interference between noise photons is reduced can also be suitably applied to quantum information processing using squeezed vacuum.

In addition, the squeezed vacuum producing device 1 according to the present embodiment further includes the optical pulse attenuation means 30 for selectively attenuating the two-wavelength optical pulse from the light output by the squeezed vacuum producing means 20. With such a configuration, it becomes easy to extract the squeezed vacuum from the light output by the nonlinear optical medium 22. In other words, the purity of the squeezed vacuum can be increased in the light output by the squeezed vacuum producing device 1.

In addition, the two-wavelength optical pulse light source 10 includes the single optical pulse light source 11 having a frequency spectral width including at least optical frequencies f1 and f2 or a spectral shape including the optical frequencies f1 and f2, and the optical wavelength filter 12 for inputting the single optical pulse light source 11 and outputting a two-wavelength optical pulse of the optical frequencies f1 and f2. With such a configuration, it is possible to easily implement the configuration of the two-wavelength optical pulse light source 10 that outputs the two-wavelength optical pulse by temporally synchronizing the first optical pulse and the second optical pulse.

The optical wavelength filter 12 is the programmable optical filter 12A, the wavelength selective filter 12B, or the plurality of notch filters 12C connected in cascade. According to this configuration, it is possible to easily implement the configuration of the two-wavelength optical pulse light source 10 that outputs a two-wavelength optical pulse in a state where a relative phase between the first optical pulse and the second optical pulse does not fluctuate.

The squeezed vacuum producing means 20 is provided with the attenuation means 21 for attenuating the intensity of optical noise at the optical frequency fo in the two-wavelength optical pulse light source 10 to an intensity ratio of 0.01 or less of the light intensity of the squeezed vacuum. With such a configuration, the squeezed vacuum is more easily extracted from the light output by the nonlinear optical medium 22. In other words, the purity of the squeezed vacuum can be further increased in the light output by the squeezed vacuum producing device 1.

Note that the technical scope of the present invention is not limited to the above-described embodiment, and various modifications can be made without departing from the gist of the present invention.

For example, when the purity of the squeezed vacuum can be sufficiently secured in the light output by the squeezed vacuum producing device 1, the optical pulse attenuation means 30 (optical pulse attenuation step) may be omitted. Similarly, the first attenuation means 21 and the second attenuation means described above may be omitted.

In the example described above, the squeezed vacuum producing means 20 generates squeezed vacuum by using third order nonlinearity of the nonlinear optical medium 22. However, the squeezed vacuum producing means 20 may generate squeezed vacuum by using second order nonlinearity of the nonlinear optical medium 22. In this case, a nonlinear optical effect for generating squeezed vacuum may be spontaneous parametric down-conversion. In this case, the optical frequency fo of the squeezed vacuum satisfies a relationship of fo=f1+f2.

In addition, it is possible to appropriately replace the constituent elements in the above-described embodiment with well-known constituent elements without departing from the gist of the present invention, and the above-described embodiment and modification examples may be appropriately combined.

### REFERENCE SIGNS LIST

1 Squeezed vacuum producing device, 10 Two-wavelength optical pulse light source, 11, Optical pulse light source, 12 Optical wavelength filter, 12A Programmable optical filter, 12B Wavelength selective filter, 12C Notch filter, 20 Squeezed vacuum producing means, 21 Attenuation means, 22 Nonlinear optical medium, 30 Optical pulse attenuation means

What is claimed is:

1. A squeezed vacuum producing device comprising:
a two-wavelength optical pulse light source with a coaxial path which synchronizes two optical pulses configured with a first optical pulse having an optical frequency f1 and a second optical pulse having an optical frequency f2 (f1≠f2) and outputs a two-wavelength optical pulse in a state where a relative phase between the first optical pulse and the second optical pulse does not fluctuate; and
a squeezed vacuum producing unit that includes a nonlinear optical medium, inputs the two-wavelength optical pulse output by the two-wavelength optical pulse light source to the nonlinear optical medium, generates squeezed vacuum having an optical frequency fo (fo≠f1 and fo≠f2) by a nonlinear optical effect, and outputs the squeezed vacuum.

2. The squeezed vacuum producing device according to claim 1, further comprising an optical pulse attenuation unit for selectively attenuating the two-wavelength optical pulse from the light output by the squeezed vacuum producing unit.

3. The squeezed vacuum producing device according to claim 1, wherein the two-wavelength optical pulse light source includes
a single optical pulse light source having a frequency spectral width including at least the optical frequencies f1 and f2 or a spectral shape including the optical frequencies f1 and f2, and
an optical wavelength filter for inputting the single optical pulse light source and outputting a two-wavelength optical pulse of the optical frequencies f1 and f2.

4. The squeezed vacuum producing device according to claim 3, wherein the optical wavelength filter is a programmable optical filter, a wavelength selective filter, or a plurality of notch filters connected in cascade.

5. The squeezed vacuum producing device according to claim 1, wherein the squeezed vacuum producing unit includes an attenuation unit for attenuating an intensity of optical noise at the optical frequency fo in the two-wavelength optical pulse light source to an intensity ratio of 0.01 or less of a light intensity of the squeezed vacuum.

6. A squeezed vacuum producing method comprising:
causing a two-wavelength optical pulse light source to synchronize two optical pulses configured with a first optical pulse having an optical frequency f1 and a second optical pulse having an optical frequency f2 (f1≠f2) in a state where a relative phase between the first optical pulse and the second optical pulse does not fluctuate, and to output a two-wavelength optical pulse; and
inputting the synchronized and output two-wavelength optical pulse to a nonlinear optical medium to generate squeezed vacuum having an optical frequency fo (fo≠f1 and fo≠f2) by a nonlinear optical effect and outputting the squeezed vacuum.
